(19) United States
(12) Patent Application Publication
(10) Pub. No.: US 2017/0054970 A1
(43) Pub. Date: Feb. 23, 2017

(54) SYSTEM AND METHOD FOR CALIBRATING ALIGNMENT OF A THREE-DIMENSIONAL DISPLAY WITHIN A VEHICLE

(71) Applicant: Visteon Global Technologies, Inc., Van Buren Township, MI (US)

(72) Inventors: Ankit Singh, Holland, MI (US); Lawrence Robert Hamelink, Hamilton, MI (US)

(73) Assignee: Visteon Global Technologies, Inc., Van Buren Township, MI (US)

(21) Appl. No.: 15/306,514

(22) PCT Filed: Apr. 30, 2015
(86) PCT No.: PCT/US15/28631

§ 371 Date: Oct. 25, 2016

Related U.S. Application Data
(60) Provisional application No. 61/986,803, filed on Apr. 30, 2014.

(51) Int. Cl. H04N 13/04; B60R 1/00; B60K 35/00

(52) U.S. Cl. CPC H04N 13/0425; H04N 13/0497; H04N 13/0468; H04N 13/0409; B60K 35/00; B60R 1/00; B60K 2350/1072; B60K 2350/352; B60K 2350/2017; B60R 2300/8006; B60R 2300/20

(57) ABSTRACT

A vehicle display assembly includes a three-dimensional (3D) display and a display control system configured to control a first output direction of a left-eye portion of an image and a second output direction of a right-eye portion of the image. In addition, the vehicle display assembly includes a camera assembly configured to monitor a position of a head of a vehicle occupant and a visual output of the 3D display. The vehicle display assembly further includes a 3D control system communicatively coupled to the camera assembly and to the display control system. The 3D control system is configured to determine an alignment calibration based on the position of the head of the vehicle occupant and the visual output, and to instruct the display control system to control the first and second output directions based on the position of the head of the vehicle occupant and the alignment calibration.

### CROSS REFERENCE TO RELATED APPLICATION

This application claims priority from and the benefit of U.S. Provisional Patent Application Ser. No. 61/986,803, entitled “SYSTEM AND METHOD FOR CALIBRATING ALIGNMENT OF A THREE-DIMENSIONAL DISPLAY WITHIN A VEHICLE”, filed Apr. 30, 2014, which is hereby incorporated by reference in its entirety.

### BACKGROUND

The invention relates generally to a system and method for calibrating alignment of a three-dimensional display within a vehicle.

Certain vehicles include a variety of displays configured to convey information to a driver. For example, an instrument panel may include gauges and/or displays configured to present information related to vehicle speed, fuel quantity, fuel efficiency, oil temperature, oil pressure, coolant temperature and engine speed, among other parameters. Certain instrument panels also include graphical representations of the displayed information. For example, the instrument panel may include a display configured to present a graph of fuel efficiency as a function of time. In addition, the vehicle may include another display within a center console configured to present further graphical information to the driver. For example, the center console display may present information related to navigation, environmental controls, and audio functions, among other information.

Certain vehicles may employ one or more three-dimensional (3D) displays to facilitate efficient presentation of information to the driver. The 3D displays may be autostereoscopic, thereby enabling the driver to view a 3D image on the display without the use of 3D glasses (e.g., polarized glasses, LCD shutter glasses, etc.). For example, the autostereoscopic 3D display may include multiple pixels configured to form an image on a display surface, and a parallax barrier positioned adjacent to the display surface to separate the image into a left-eye portion and a right-eye portion. To view the image in three dimensions, the left-eye portion of the image is directed toward the left eye of the viewer, and the right-eye portion of the image is directed toward the right eye of the viewer. Unfortunately, due to variations in the seating position of the driver (e.g., lateral seating position) and/or driver movement in response to vehicle dynamics (e.g., in the lateral direction), the left-eye and right-eye portions of the image may not be directed toward the respective eyes of the driver while the head of the driver is directed toward the display. Consequently, the driver may not be able to view the image in three-dimensions.

### BRIEF DESCRIPTION OF THE INVENTION

The present invention relates to a vehicle display assembly including a three-dimensional (3D) display having multiple pixels configured to form an image on a display surface, and an image separating device configured to separate the image into a left-eye portion and a right-eye portion. The vehicle display assembly also includes a display control system configured to control a first output direction of the left-eye portion of the image and a second output direction of the right-eye portion of the image. In addition, the vehicle display assembly includes a camera assembly configured to monitor a position of a head of a vehicle occupant and a visual output of the 3D display. The vehicle display assembly further includes a 3D control system communicatively coupled to the camera assembly and to the display control system. The 3D control system is configured to determine an alignment calibration based on the position of the head of the vehicle occupant and the visual output, and to instruct the display control system to control the first and second output directions based on the position of the head of the vehicle occupant and the alignment calibration.

The present invention also relates to a vehicle display assembly including a three-dimensional (3D) display having multiple pixels configured to form an image on a display surface, and an image separating device configured to separate the image into a left-eye portion and a right-eye portion. The vehicle display assembly also includes a display control system configured to control a first output direction of the left-eye portion of the image and a second output direction of the right-eye portion of the image. In addition, the vehicle display assembly includes a camera assembly configured to monitor a position of a head of a vehicle occupant and the image formed on the display surface. The vehicle display assembly also includes a 3D control system communicatively coupled to the camera assembly and to the display control system. The 3D control system includes a memory operatively coupled to a processor and configured to store data and instructions that, when executed by the processor, cause the 3D control system to perform a method. The method includes receiving a first signal from the camera assembly indicative of the position of the head of the vehicle occupant, and receiving a second signal from the camera assembly indicative of the image formed on the display surface. The method also includes determining an alignment calibration based on the first signal and the second signal, and determining a first desired output direction of the left-eye portion of the image and a second desired output direction of the right-eye portion of the image based on the alignment calibration and the first signal. In addition, the method includes outputting a third signal to the display control system indicative of instructions to adjust the first output direction toward the first desired output direction and to adjust the second output direction toward the second desired output direction.

The present invention further relates to a method of operating a vehicle display assembly including receiving a first signal from a camera assembly indicative of a position of a head of a vehicle occupant. The method also includes receiving a second signal from the camera assembly indicative of an image formed on a display surface of a three-dimensional (3D) display. The 3D display comprises multiple pixels configured to form the image on the display surface and an image separating device configured to separate the image into a left-eye portion and a right-eye portion. In addition, the method includes determining an alignment calibration based on the first signal and the second signal, and determining a first desired output direction of the left-eye portion of the image and a second desired output direction of the right-eye portion of the image based on the alignment calibration and the first signal. The method also includes outputting a third signal to a display control system indicative of the first and second desired output directions.

### DRAWINGS

FIG. 1 is a perspective view of an exemplary vehicle that may include a vehicle display assembly configured to calibrate alignment of a three-dimensional display based on occupant head position and an analysis of a test image presented by the display.

FIG. 2 is a perspective view of a part of the interior of the vehicle of FIG. 1.

FIG. 3 is a perspective view of an embodiment of a three-dimensional display having a parallax barrier.

FIG. 4 is a schematic diagram of an embodiment of a vehicle display assembly that may be employed within the vehicle of FIG. 1.

FIG. 5 is a schematic diagram of an alternative embodiment of a vehicle display assembly that may be employed within the vehicle of FIG. 1.

FIG. 6 is a flow diagram of an embodiment of a method of operating a vehicle display assembly.

### DETAILED DESCRIPTION

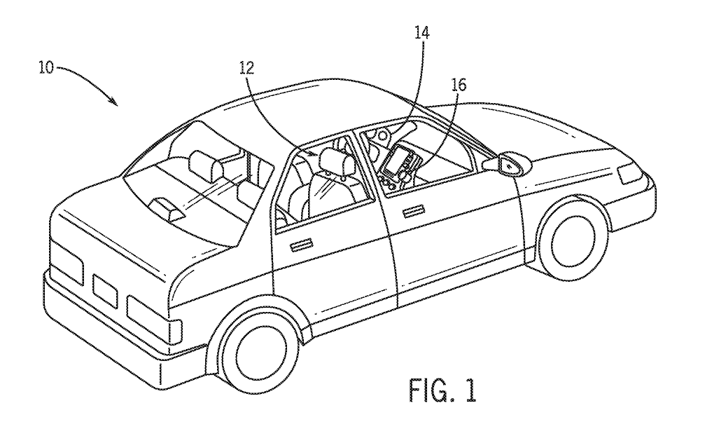

FIG. 1 is a perspective view of an exemplary vehicle 10 that may include a display assembly configured to calibrate alignment of a three-dimensional (3D) display based on occupant head position and an analysis of a test image presented by the display. As illustrated, the vehicle 10 includes an interior 12 having an instrument panel 14 and a center console 16. As discussed in detail below, a display assembly within the instrument panel 14 and/or the center console 16 may present 3D images to the driver and/or the front passenger. For example, in certain embodiments, the display assembly includes a 3D display having multiple pixels configured to form an image on a display surface. The 3D display also includes an image separating device (e.g., parallax barrier) configured to separate the image into a left-eye portion and a right-eye portion. The vehicle display assembly also includes a display control system (e.g., an actuator coupled to the image separating device, an actuator coupled to the 3D display, a display controller, etc.) configured to control a first output direction of the left-eye portion of the image and a second output direction of the right-eye portion of the image. In addition the vehicle display assembly includes a camera assembly (e.g., including one or more cameras) configured to monitor a position of a head of a vehicle occupant (e.g., a driver or passenger) and a visual output of the 3D display.

Furthermore, the vehicle display assembly includes a 3D control system communicatively coupled to the camera assembly and to the display control system. The 3D control system is configured to determine an alignment calibration based on the position of the head of the vehicle occupant and the visual output. The 3D control system is also configured to instruct the display control system to control the first and second output directions based on the position of the head of the vehicle occupant and the alignment calibration. Accordingly, the left-eye portion of the image may be directed toward the left eye of the vehicle occupant, and the right-eye portion of the image may be directed toward the right eye of the vehicle occupant, while the head of the vehicle occupant is directed toward the 3D display. As a result, vehicle occupants may be able to view an image on the display in three dimensions despite variations in seating position (e.g., lateral seating position) and/or movement in response to vehicle dynamics (e.g., in the lateral direction).

As used herein, the term “three-dimensional” or “3D” refers to an image that appears to have three dimensions, as compared to a two-dimensional perspective view of a 3D object. Such images may be known as stereoscopic images. The term “3D display” references to a display device capable of producing a 3D image. As discussed in detail below, the present embodiments may employ autostereoscopic displays that enable a vehicle occupant to view a 3D image on the display without the use of 3D glasses (e.g., polarized glasses, LCD shutter glasses, etc.). For example, the autostereoscopic 3D display may include multiple pixels configured to form an image on a display surface, and a parallax barrier positioned adjacent to the display surface to separate the image into a left-eye portion and a right-eye portion. To view the image in three dimensions, the left-eye portion of the image is directed toward the left eye of the vehicle occupant, and the right-eye portion of the image is directed toward the right eye of the vehicle occupant. Consequently, the right eye views the right-eye portion of the image, and the left eye views the left-eye portion of the image. Because each eye sees a different image, the 3D display appears to produce a 3D image.

As used herein, the terms “output direction” and “directed toward”, when referring to the left-eye portion and the right-eye portion of the image, refer to establishing a location of a viewing point at which the eye (e.g., left eye or right eye) effectively views the corresponding portion (e.g., left-eye portion or right-eye portion) of the image. Accordingly, while the left-eye portion of the image is directed toward the left eye of the occupant, the left eye effectively sees the left-eye portion of the image, and while the right-eye portion of the image is directed toward the right eye of the occupant, the right eye effectively sees the right-eye portion of the image. In addition, changing the output direction of the left-eye portion and/or the right-eye portion of the image may be accomplished by changing the location of the viewing point at which the respective eye effectively views the corresponding portion of the image. For example, the output direction may be adjusted by moving the parallax barrier relative to the display surface, rotating the display relative to the head of the vehicle occupant, changing the output of the pixels of the display, or a combination thereof, among other suitable techniques.

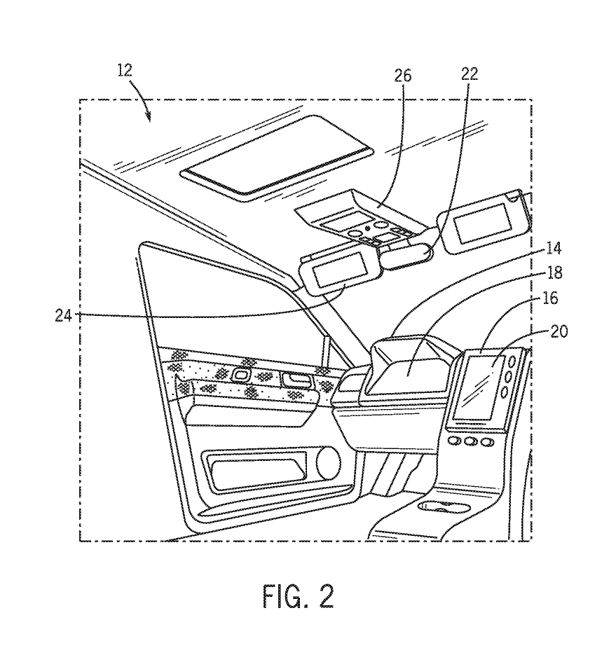

FIG. 2 is a perspective view of a part of the interior 12 of the vehicle 10 of FIG. 1. As illustrated, the instrument panel 14 includes a first graphical display 18, and the center console 16 includes a second graphical display 20. As discussed in detail below, the first graphical display 18 and/or the second graphical display 20 may be configured to present 3D images to a vehicle occupant. As will be appreciated, variations in seating position (e.g., lateral seating position) and/or vehicle dynamics may place a head of the occupant in various positions within the vehicle interior 12. Accordingly, the vehicle display assembly is configured to monitor the position of the occupant head, and to adjust an output of the display (e.g., the first display 18 and/or the second display 20) based on the occupant head position. For example, the vehicle display assembly may be configured to automatically direct a left-eye portion of an image to the left eye of the occupant and to direct a right-eye portion of the image to the right eye of the occupant, thereby enabling the vehicle occupant to view the image in three dimensions.

In certain embodiments, the vehicle display assembly is configured to calibrate alignment of the display with the head of the vehicle occupant during an initialization process of the vehicle electronic systems (e.g., at vehicle startup). As discussed in detail below, this process includes displaying a test image on the display, monitoring the test image and the position of the occupant head with a camera assembly, and determining an alignment calibration based on the head position and visual output from the test image. The alignment calibration is then used to enhance the alignment of the respective left-eye/right-eye portions of the image with the occupant eyes during the automatic image direction process described above. As a result, the quality and/or accuracy of the three dimensional image may be enhanced.

While the illustrated interior 12 includes graphical displays within the instrument panel 14 and the center console 16, it should be appreciated that alternative embodiments may include graphical displays located within other components of the vehicle interior. For example, in certain embodiments, a graphical display may be disposed within a rearview mirror 22, a sun visor 24, an overhead console 26, and/or any other visible surface within the interior 12 of the vehicle 10. In such embodiments, an output of the graphical displays (e.g., based on a position of the image separating device, an orientation of the display, and/or an output of the pixels within the display) may be adjusted based on occupant head position to enable the occupant to view images on the displays in three dimensions.

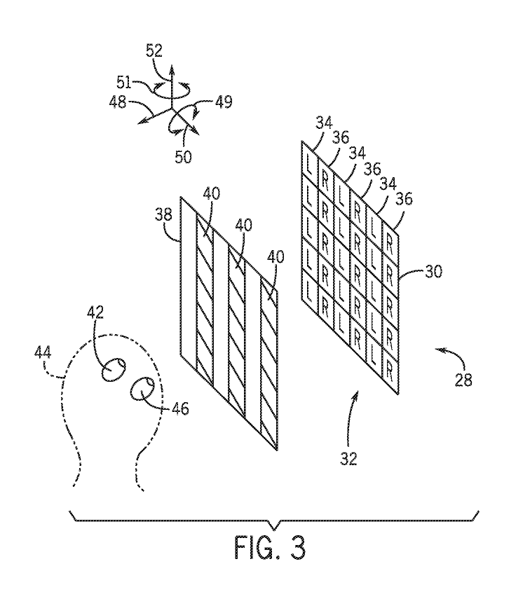

FIG. 3 is a perspective view of an embodiment of a 3D display 28 having a parallax barrier. In the illustrated embodiment, the 3D display 28 includes an array of pixels 30 configured to form an image on a display surface 32. As illustrated, the array of pixels 30 is divided into alternating columns of left-eye pixels 34 and right-eye pixels 36. As discussed in detail below, the left-eye pixels 34 are configured to form a left-eye portion of a 3D image, and the right-eye pixels 36 are configured to form a right-eye portion of the 3D image. A parallax barrier 38 is positioned adjacent to the display surface 32 to separate the image into the left-eye portion and the right-eye portion. In certain embodiments, the parallax barrier 38 is movable relative to the display surface 32. However, in alternative embodiments, the parallax barrier 38 may be fixed (e.g., non-movable) relative to the display surface 32. As illustrated, the parallax barrier 38 includes substantially opaque regions 40. The substantially opaque regions 40 are configured to block the right-eye portion of the image from a left eye 42 of the vehicle occupant 44. Similarly, the substantially opaque regions 40 are configured to block the left-eye portion of the image from a right eye 46 of the vehicle occupant 44. Accordingly, while the desired alignment is established, the left eye 42 sees the left-eye portion of the image, and the right eye 46 sees the right-eye portion of the image, thereby enabling the occupant to view the image in three dimensions. While the illustrated 3D display includes a parallax barrier, it should be appreciated that alternative 3D displays may include other suitable devices (e.g., image separating devices) for separating the image into a left-eye portion and a right-eye portion (e.g., a lenticular array).

As illustrated, a position of the parallax barrier 38 may be defined in terms of a longitudinal axis 48, a lateral axis 50, and a vertical axis 52. In certain embodiments, the parallax barrier 38 is moveable relative to the display surface 32. For example, the parallax barrier 38 may be moved along the longitudinal axis 48, along the lateral axis 50, or a combination thereof. By way of example, the position of the parallax barrier 38 along the lateral axis 50 may be adjusted to control the output directions of the left-eye portion of the image and the right-eye portion of the image. As discussed in detail below, the left-eye portion of the image may be directed toward the left eye 42 of the occupant 44, and the right-eye portion of the image may be directed toward the right eye 46 of the occupant, thereby enabling the occupant to view the image in three dimensions. In further embodiments, the parallax barrier 38 may also be configured to move along the longitudinal axis 48 to facilitate directing the left-eye and right-eye portions of the image toward the respective eyes of the occupant 44. The parallax barrier 38 may also be configured to rotate about one or more of the axes.

In certain embodiments, an orientation of the 3D display 28 may be adjusted based on the position of the head of the occupant 44 and an alignment calibration. For example, the longitudinal axis 48, which may be perpendicular to the display surface 32, may be directed toward the occupant head. As a result, the left-eye portion of the image may be directed toward the left eye 42, and the right-eye portion of the image may be directed toward the right eye 46. If a lateral position of the occupant head varies during operation of the vehicle (e.g., due to vehicle dynamics), the display 28 may be rotated in a direction 51 about the vertical axis 52. In this manner, the 3D display 28 may be directed toward the head of the vehicle occupant 44 despite movement of the occupant during operation of the vehicle.

In certain embodiments, the 3D display 28 may include a wide viewing angle in the vertical direction. Accordingly, an occupant may be able to view 3D images on the display 28 despite significant angular variations between the occupant head and the display (at least in a direction 49 about the lateral axis 50). Accordingly, in embodiments configured to orient the 3D display 28, an actuator configured to rotate the display 28 in the direction 49 about the lateral axis 50 may be obviated. Therefore, a single actuator may be employed to rotate the 3D display 28 in the direction 51 about the vertical axis 52 in response to movement (e.g., lateral movement) of the occupant head.

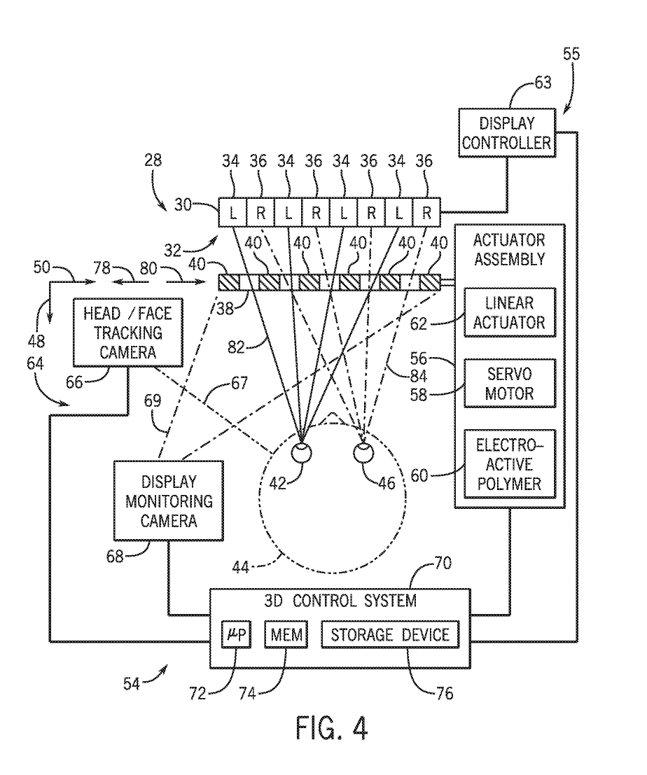

FIG. 4 is a schematic diagram of an embodiment of a vehicle display assembly 54 that may be employed within the vehicle 10 of FIG. 1. As illustrated, the vehicle display assembly 54 includes the 3D display 28, which is configured to present a 3D image to a vehicle occupant (e.g., a driver or a passenger within the vehicle 10). The vehicle display assembly 54 also includes a display control system 55 configured to control output directions of the left-eye and right-eye portions of the image. In the illustrated embodiment, the display control system 55 includes an actuator assembly 56 coupled to the parallax barrier 38 and configured to adjust a position of the parallax barrier 38 relative to the display surface 32. In certain embodiments, the actuator assembly 56 includes one or more electrical servo motors 58 configured to move the parallax barrier 38 along one or more axes. For example, a first servo motor 58 may be configured to translate the parallax barrier 38 along the lateral axis 50, and a second servo motor 58 may be configured to translate the parallax barrier along the longitudinal axis 48. In such a configuration, the position of the parallax barrier 38 may be adjusted relative to the display surface 32.

In addition, the actuator assembly 56 may include one or more electroactive polymers 60 to adjust the position of the parallax barrier 38. As will be appreciated, electroactive polymers 60 are configured to change shape in response to application of electrical current. Similar to the servo motors 58, the electroactive polymers 60 may be configured to facilitate translation of the parallax barrier 38 along multiple axes. Furthermore, the actuator assembly 56 may include one or more linear actuators 62 to adjust the position of the parallax barrier 38. The actuator assembly 56 may include only servo motors 58, only electroactive polymers 60, only linear actuators 62, a combination of servo motors, electroactive polymers, and linear actuators, or any other device suitable for translating the parallax barrier 38 in one or more axes.

In the illustrated embodiment, the display control system 55 includes a display controller 63 communicatively coupled to the 3D display 28. As discussed in detail below, the display controller 63 is configured to control the image presented on the display surface 32 by adjusting the output of the pixels 30. For example, the display controller 63 may adjust the position of the left-eye pixels 34 and the right-eye pixels 36 along the display surface to direct a left-eye image to the left eye 42 of the vehicle occupant 44 and to direct a right-eye image to the right eye 46 of the vehicle occupant 44, thereby enhancing the quality and/or accuracy of the three dimensional image.

The vehicle display assembly 54 also includes a camera assembly 64 in the illustrated embodiment. The camera assembly 64 is configured to monitor a position of a head of the vehicle occupant 44 within the vehicle interior 12. The camera assembly 64 is also configured to monitor visual output from the image formed on the display surface 32 of the 3D display 28. In the illustrated embodiment, the camera assembly 64 includes a first optical sensor, such as the illustrated head/face tracking camera 66, configured to monitor the position of the occupant head based on an image, or series of images, of the vehicle interior 12. For example, the head/face tracking camera 66 may direct a field of view 67 toward a desired region of the vehicle interior 12, analyze an image, or series of images, of the desired region to identify an occupant head or face, and determine the position of the head relative to one or more reference points (e.g., fixed markers within the vehicle interior). The head/face tracking camera 66 may then output a signal indicative of the occupant head position. In alternative embodiments, the head/facing tracking camera 66 may output an image of the vehicle interior 12 for analysis by a control system.

In the illustrated embodiment, the camera assembly 64 also includes a second optical sensor, such as the illustrated display monitoring camera 68. The display monitoring camera is configured to monitor the visual output of the 3D display 28 based on an image, or series of images, of the 3D display 28. For example, the display monitoring camera 68 may direct a field of view 69 toward the 3D display 28, and monitor an image, or series of images, of the visual output from the 3D display 28 to facilitate determination of an alignment calibration. As discussed in detail below, during the initialization of the vehicle electronic systems (e.g., during startup of the vehicle), the 3D display may present a test image that is monitored by the display monitoring camera 68 to facilitate determination of an alignment calibration.

As illustrated, the vehicle display assembly 54 also includes a 3D control system 70 communicatively coupled to each camera of the camera assembly 64, and to the actuator assembly 56 and the display controller of the display control system 55. The 3D control system 70 is configured to determine an alignment calibration based on the position of the head of the vehicle occupant (e.g., as monitored by the head/face tracking camera 66) and the visual output from the 3D display (e.g., as monitored by the display monitoring camera 68). The 3D control system 70 is also configured to instruct the display control system 55 (e.g., the actuator assembly 56 and/or the display controller 63) to control the output directions of the left-eye portion of the image and the right-eye portion of the image based on the position of the head of the vehicle occupant and the alignment calibration. As a result, the left-eye portion of the image is directed toward the left eye of the vehicle occupant, and the right-eye portion of the image is directed toward the right eye of the vehicle occupant, thereby enabling the vehicle occupant to view an image on the display in three dimensions despite variations in seating position (e.g., in lateral seating position) and/or movement (e.g., in the lateral direction) in response to vehicle dynamics.

In the illustrated embodiment, the 3D control system 70 include a processor, such as the illustrated microprocessor 72, a memory device 74, and a storage device 76. The 3D control system 70 may also include additional processors, additional memory devices, additional storage devices, and/or other suitable components. The processor 72 may be used to execute software, such as software for controlling the vehicle display assembly 54, and so forth. Moreover, the processor 72 may include multiple microprocessors, one or more “general-purpose” microprocessors, one or more special-purpose microprocessors, and/or one or more application specific integrated circuits (ASICS), or some combination thereof. For example, the processor 72 may include one or more reduced instruction set (RISC) processors.

The memory device 74 may include a volatile memory, such as random access memory (RAM), and/or a nonvolatile memory, such as ROM. The memory device 74 may store a variety of information and may be used for various purposes. For example, the memory device 74 may store processor-executable instructions (e.g., firmware or software) for the processor 72 to execute, such as instructions for controlling the vehicle display assembly 54. The storage device 76 (e.g., nonvolatile storage) may include read-only memory (ROM), flash memory, a hard drive, or any other suitable optical, magnetic, or solid-state storage medium, or a combination thereof. The storage device 76 may store data (e.g., alignment calibration data, relative position data, etc.), instructions (e.g., software or firmware for controlling the vehicle display assembly, etc.), and any other suitable data.

In certain embodiments, during initialization of the vehicle electronic systems (e.g., during startup of the vehicle 10), the display controller 63 outputs a signal to the 3D display 28 instructing the pixels 30 to form a test image on the display surface 32. The test image may include any suitable pattern or image suitable for alignment calibration. By way of example only, the display controller 63 may instruct the left-eye pixels 34 to emit red light and the right-eye pixels 36 to emit blue light. However, other test images/patterns may be utilized in alternative embodiments.

While the test image is displayed, the head/face tracking camera 66 monitors the vehicle interior 12 and outputs a first signal indicative of the position of the head of the vehicle occupant 44. In addition, the display monitoring camera 68 monitors the visual output of the 3D display 28 and outputs a second signal indicative of the test image formed on the display surface. The 3D control system 70 then determines an alignment calibration based on the first signal and the second signal. The alignment calibration may be used to establish a relationship between the display output (e.g., based on the output of the pixels 30 and/or the position of the parallax barrier) and the occupant head position. For example, during the alignment calibration process, the 3D control system 70 may determine an expected visual output of the display 28 at the location of the display monitoring camera 68, which corresponds to effectively directing the left-eye portion of the image toward the left eye 42 of the occupant 44 and the right-eye portion of the image toward the right eye 46 of the occupant 44. The expected visual output may be based on the position of the display 28, the position of the head of the vehicle occupant 44, the position of the display monitoring camera 68, and the test image. For example, if the test image includes alternating columns of red light emitted by the left-eye pixels 34 and blue light emitted by the right-eye pixels 36, the expected visual output at the display monitoring camera 68 may include an expected pattern of red and blue columns, which corresponds to the left-eye portion of the image being directed toward the left eye 42 of the occupant 44 and the right-eye portion of the image being directed toward the right eye 46 of the occupant 44. Accordingly, the expected visual output of the display 28 at the display monitoring camera 68 may correspond to display output (e.g., based on the output of the pixels 30 and/or the position of the parallax barrier) in which the left eye 42 receives a substantially solid red image and the right eye 46 receives a substantially solid blue image.

The 3D control system 70 may then compare the expected visual output of the display at the display monitoring camera 68 to the image received by the display monitoring camera 68. If the images do not substantially correspond to one another (e.g., the difference between the expected visual output and the monitored image exceeds a desired threshold), the 3D control system 70 may instruct the display control system 55 to adjust the output direction of the left-eye portion of the image and the right-eye portion of the image until the expected visual output of the display at the display monitoring camera 68 substantially corresponds to the image received by the display monitoring camera 68. For example, the 3D control system 70 may instruct the actuator assembly 56 to adjust the position (e.g., lateral position) of the parallax barrier 38 and/or instruct the display controller 63 to adjust the output of the pixels (e.g., by changing the order of the left-eye and right-eye pixels, etc.) until the image received by the camera 68 substantially corresponds to the expected visual output.

Once the images substantially correspond to one another, the 3D control system 70 may store data indicative of the alignment calibration (e.g., in the storage device 76). For example, the alignment calibration may include one or more parameters that may be used in a relationship (e.g., equation, lookup table, etc.) between occupant head position and parallax barrier position. In addition, the alignment calibration may include one or more parameters that may be used in a relationship (e.g., equation, lookup table, etc.) between occupant head position and pixel output. As discussed in detail below, the alignment calibration may be used in conjunction with the occupant head position (e.g., as monitored by the head/facing tracking camera 66) to enhance the alignment of the respective left-eye/right-eye portions of the image with the occupant eyes, thereby enhancing the quality and/or accuracy of the three dimensional image.

While the process of determining an alignment calibration is described above with reference to a red/blue test image, it should be appreciated that alternative embodiments may employ other suitable test images to facilitate comparison of the expected visual output to the monitored image. In addition, the alignment calibration may include data related to positioning the parallax barrier and/or controlling the output of the pixels. As discussed in detail below, the alignment calibration may also include data related to orienting the 3D display relative to the head of the vehicle occupant. Furthermore, in certain embodiments, the alignment calibration may be determined without adjusting the output direction of the left-eye portion of the image and the right-eye portion of the image. For example, the 3D control system may determine the alignment calibration directly from the comparison between the expected visual output of the display at the display monitoring camera 68 to the image received by the display monitoring camera 68. In addition, while the alignment calibration process may be performed during initialization of the vehicle electronic systems in certain embodiments, it should be appreciated that the alignment calibration process may additionally or alternatively be manually initiated (e.g., in response to occupant input).

Once the alignment calibration is determined, the 3D display may present a desired image instead of the test image. In addition, the 3D control system 70 determines a first desired output direction of the left-eye portion of the image and a second desired output direction of the right-eye portion of the image based on the alignment calibration and the position of the occupant head. For example, the 3D control system 70 may determine a desired position (e.g., lateral position) of the parallax barrier 38 relative to the display surface 32 based on the alignment calibration and the position of the occupant head. In addition, or alternatively, the 3D control system 70 may determine a desired output of the pixels 30 (e.g., a desired order of the left-eye and right-eye pixels, etc.) based on the alignment calibration and the position of the occupant head.

The 3D control system 70 may then output a signal to the display control system 55 indicative of instructions to adjust the output direction of the left-eye portion of the image toward the first desired output direction and to adjust the output direction of the right-eye portion of the image toward the second desired output direction. For example, the 3D control system 70 may instruct the actuator assembly 56 to move the parallax barrier 38 in a first direction 78 or a second direction 80 along the lateral axis 50 toward the desired barrier position. With the parallax barrier 38 in the desired position, the left-eye portion 82 of the image may be directed toward the left eye 42 of the occupant 44, and the right-eye portion 84 of the image may be directed toward the right eye 46 of the occupant 44. In further embodiments, the actuator assembly 56 may also be configured to move the parallax barrier 38 in the longitudinal direction 48 and/or the vertical direction to facilitate directing the left-eye and right-eye portions of the image in the respective desired directions.

In certain embodiments, the 3D control system 70 may instruct the display controller 63 to adjust the output of the pixels 30 to facilitating directing the left-eye portion 82 of the image toward the left eye 42 of the occupant 44 and directing the right-eye portion 84 of the image toward the right eye 46 of the occupant 44. For example, the display controller 63 may change the order of the left-eye pixels 34 and the right-eye pixels 36 based on the first and second desired output directions. In certain embodiments, the 3D control system 70 may concurrently control the display controller 63 and the actuator 56 to facilitate directing the left-eye and right-eye portions of the image in the respective desired directions.

By way of example, if the head of the occupant 44 moves to the right (e.g., in response to a turn), the vehicle display assembly 54 automatically adjusts the output direction of the left-eye and right-eye portions of the image to compensate for the new driver head position. For example, if the head/face tracking camera 66 detects movement of the head to the right, the 3D control system 70 may instruct the actuator assembly 56 to move the parallax barrier 40 and/or the display controller 63 to adjust the output of the pixels based on the monitored head position and the alignment calibration. As a result, the alignment of the respective left-eye/right-eye portions of the image with the occupant eyes may be enhanced, thereby enhancing the quality and/or accuracy of the three dimensional image. This automatic output direction process may repeat (e.g., periodically) during operation of the vehicle, while using the alignment calibration determined during initialization of the vehicle electronic systems. Alternatively, the alignment calibration may be redetermined in response to operator input or automatically (e.g., at a desired time interval).

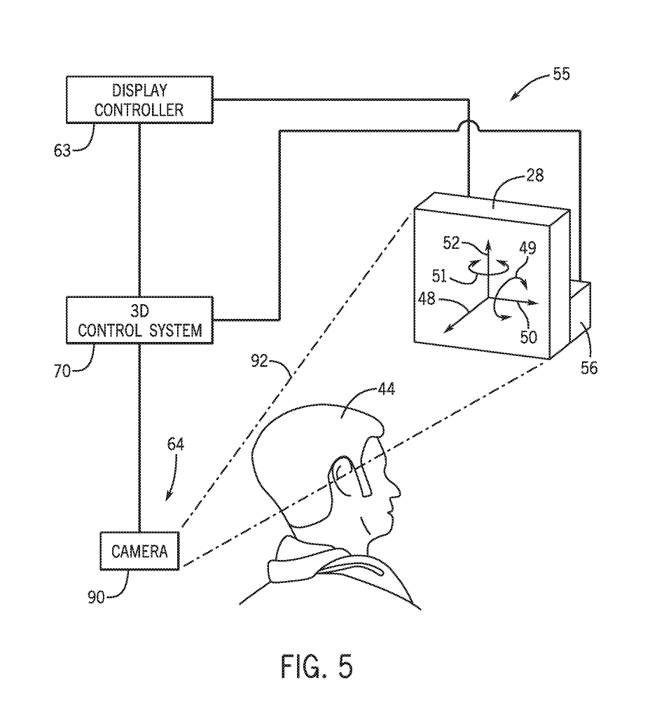

FIG. 5 is a schematic diagram of an alternative embodiment of a vehicle display assembly that may be employed within the vehicle of FIG. 1. In the illustrated embodiment, the camera assembly 64 includes a single camera 90 configured to monitor the position of the head of the vehicle occupant 44 and to monitor the visual output of the 3D display 28. As illustrated, the camera 90 is positioned and oriented such that a field of view 92 of the camera 90 is directed toward the occupant head and the 3D display 28. Utilizing a single camera to monitor the occupant head position and visual output of the display may reduce costs, as compared to configurations that utilize independent cameras, such as a head/face tracking camera and a display monitoring camera.

Furthermore, in the illustrated embodiment, the display control system 55 includes an actuator (e.g., within the actuator assembly 56) coupled to the display 28 and configured to orient the display relative to the head of the vehicle occupant 44. Similar to the embodiment described above with reference to FIG. 4, the actuator may include a linear actuator, a servo motor, an electroactive polymer, or a combination thereof. The actuator may be configured to rotate the 3D display about the vertical axis 52 in the direction 51.

In the illustrated embodiment, the alignment calibration may be determined by monitoring the visual output of the display 28 and the occupant head position with the camera 90. For example, the camera 90 may output a first signal indicative of the position of the head of the vehicle occupant 44 and a second signal indicative of visual output from a test image formed on the display surface (e.g., the first and second signals may be the same signal indicative of the image received by the camera). The 3D control system 70 may then determine an alignment calibration based on the first signal and the second signal. By way of example, the 3D control system 70 may compare the expected visual output of the display at the camera 90 to the image (e.g., portion of the image corresponding to the display output) received by the camera 90. If the images do not substantially correspond to one another (e.g., the difference between the expected visual output and the monitored image exceeds a desired threshold), the 3D control system 70 may instruct the actuator assembly 56 to adjust the orientation of the 3D display 28 until the image received by the camera 90 substantially corresponds to the expected visual output. Once the images substantially correspond to one another, the 3D control system 70 may store data indicative of the alignment calibration (e.g., in the storage device 76).

Once the alignment calibration is determined, the 3D display may present a desired image instead of the test image. In addition, the 3D control system 70 determines (e.g., periodically) a desired orientation of the 3D display 28 based on the alignment calibration and the position of the occupant head. The 3D control system 70 may then output a signal to the actuator assembly 56 indicative of instructions to adjust the orientation of the display 28. For example, the 3D control system 70 may instruct (e.g., periodically) the actuator assembly 56 to rotate the display 28 in the direction 51 about the vertical axis 52 toward the desired display orientation. With the 3D display 28 in the desired orientation, the left-eye portion of the image may be directed toward the left eye of the occupant 44, and the right-eye portion of the image may be directed toward the right eye of the occupant 44. As a result, the alignment of the respective left-eye/right-eye portions of the image with the occupant eyes may be enhanced, thereby enhancing the quality and/or accuracy of the three dimensional image.

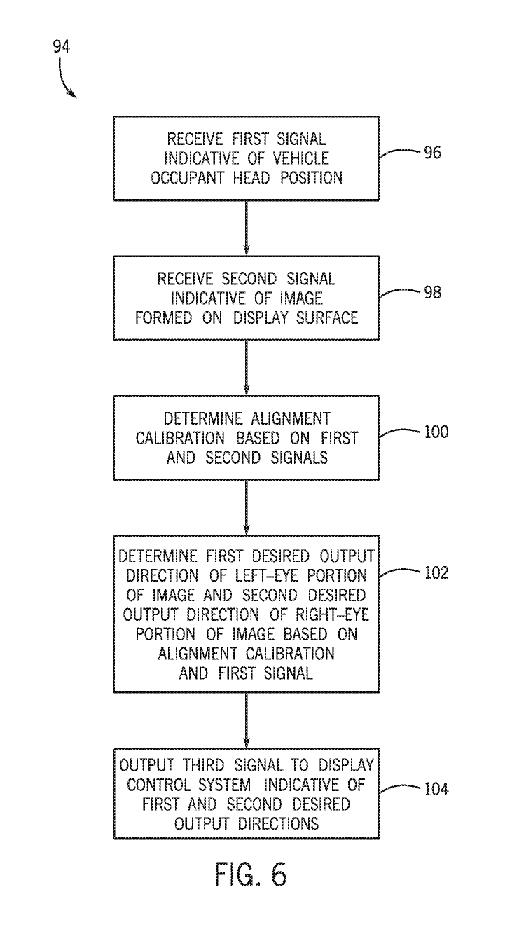

FIG. 6 is a flow diagram of an embodiment of a method 94 of operating a vehicle display assembly. First, as represented by block 96, a first signal from a camera assembly indicative of a position of a head of a vehicle occupant is received. Next, a second signal from the camera assembly indicative of an image formed on a display surface of a 3D display is received, as represented by block 98. As previously discussed, the 3D display includes an array of pixels configured to form the image on the display surface and an image separating device configured to separate the image into a left-eye portion and a right-eye portion. As represented by block 100, an alignment calibration based on the first signal and the second signal is determined. For example, in certain embodiments, during initialization of the vehicle electronic systems, the 3D display may present a test image. The alignment calibration may be determined based on a comparison of an expected visual output of the display at the location of the display-monitoring camera (e.g., which may be based on the position of the display, the position of the head of the vehicle occupant, the position of the display-monitoring camera, and the test image) and the monitored test image (e.g., as represented by the second signal).

Next, as represented by block 102, a first desired output direction of the left-eye portion of the image and a second desired output direction of the right-eye portion of the image is determined based on the alignment calibration and the first signal. For example, a desired position of the image separating device relative to the display surface may be determined, a desired orientation of the 3D display relative to the head of the vehicle occupant may be determined, a desired output of the pixel array may be determined, or a combination thereof. A third signal indicative of the first and second desired output directions is then output to a display control system, as represented by block 104. As previously discussed, the display control system may include an actuator configured to adjust the position of the image separating device based on the third signal, an actuator configured to adjust an orientation of the 3D display based on the third signal, a display controller configured to adjust an output of the pixel array based on the third signal, or a combination thereof. By adjusting at least one of the position of the image separating device, the orientation of the 3D display, and the output of the pixel array based on the third signal, the left-eye portion of the image may be directed toward the left eye of the occupant and the right-eye portion of the image may be directed toward the right eye of the occupant. As a result, the quality and/or accuracy of the three dimensional image may be enhanced.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle display assembly, comprising:
a three-dimensional (3D) display comprising a plurality of pixels configured to form an image on a display surface, and an image separating device configured to separate the image into a left-eye portion and a right-eye portion;
a display control system configured to control a first output direction of the left-eye portion of the image and a second output direction of the right-eye portion of the image;
a camera assembly configured to monitor a position of a head of a vehicle occupant and a visual output of the 3D display; and
a 3D control system communicatively coupled to the camera assembly and to the display control system, wherein the 3D control system is configured to determine an alignment calibration based on the position of the head of the vehicle occupant and the visual output, and to instruct the display control system to control the first and second output directions based on the position of the head of the vehicle occupant and the alignment calibration.

2. The vehicle display assembly of claim 1, wherein the image separating device comprises a parallax barrier.

3. The vehicle display assembly of claim 1, wherein the display control system comprises an actuator coupled to the image separating device, and the actuator is configured to adjust a position of the image separating device relative to the display surface.

4. The vehicle display assembly of claim 3, wherein the actuator comprises at least one of an electrical servo motor, an electroactive polymer, and a linear actuator.

5. The vehicle display assembly of claim 1, wherein the display control system comprises an actuator coupled to the 3D display, and the actuator is configured to adjust an orientation of the 3D display relative to the head of the vehicle occupant.

6. The vehicle display assembly of claim 3, wherein the display control system comprises a display controller communicatively coupled to the 3D display, and the display controller is configured to control the image by adjusting the output of the plurality of pixels.

7. The vehicle display assembly of claim 1, wherein the 3D control system is configured to instruct the display control system to direct the left-eye portion of the image toward a left eye of the vehicle occupant, and to direct the right-eye portion of the image toward a right eye of the vehicle occupant.

8. The vehicle display assembly of claim 1, wherein the camera assembly comprises a first camera configured to monitor the position of the head of the vehicle occupant, and a second camera configured to monitor the visual output of the 3D display.

9. The vehicle display assembly of claim 1, wherein the camera assembly comprises a camera configured to monitor the position the head of the vehicle occupant and the visual output of the 3D display.

10. A vehicle display assembly, comprising:
a three-dimensional (3D) display comprising a plurality of pixels configured to form an image on a display surface, and an image separating device configured to separate the image into a left-eye portion and a right-eye portion;
a display control system configured to control a first output direction of the left-eye portion of the image and a second output direction of the right-eye portion of the image;
a camera assembly configured to monitor a position of a head of a vehicle occupant and the image formed on the display surface; and
a 3D control system communicatively coupled to the camera assembly and to the display control system, wherein the 3D control system comprises a memory operatively coupled to a processor and configured to store data and instructions that, when executed by the processor, cause the 3D control system to perform a method comprising:
receiving a first signal from the camera assembly indicative of the position of the head of the vehicle occupant;
receiving a second signal from the camera assembly indicative of the image formed on the display surface;
determining an alignment calibration based on the first signal and the second signal;
determining a first desired output direction of the left-eye portion of the image and a second desired output direction of the right-eye portion of the image based on the alignment calibration and the first signal; and
outputting a third signal to the display control system indicative of instructions to adjust the first output direction toward the first desired output direction and to adjust the second output direction toward the second desired output direction.

11. The vehicle display assembly of claim 10, wherein the first desired output direction is directed toward a left eye of the vehicle occupant and the second desired output direction is directed toward a right eye of the vehicle occupant.

12. The vehicle display assembly of claim 10, wherein determining the first and second desired output directions comprises determining a desired position of the image separating device relative to the display surface, and wherein the display control system comprises and actuator configured to adjust a position of the image separating device based on the third signal.

13. The vehicle display assembly of claim 10, wherein determining the first and second desired output directions comprises determining a desired orientation of the 3D display relative to the head of the vehicle occupant, and wherein the display control system comprises an actuator configured to adjust an orientation of the 3D display based on the third signal.

14. The vehicle display assembly of claim 10, wherein determining the first and second desired output directions comprises determining a desired output of the plurality of pixels, and wherein the display control system comprises a display controller configured to adjust an output of the plurality of pixels based on the third signal.

15. The vehicle display assembly of claim 10, wherein the camera assembly comprises a first camera configured to monitoring the position of the head of the vehicle occupant and a second camera configured to monitor the image formed on the display surface, or a camera configured to monitor the position of the head of the vehicle occupant and the image formed on the display surface.

16. A method of operating a vehicle display assembly, comprising:
receiving a first signal from a camera assembly indicative of a position of a head of a vehicle occupant;
receiving a second signal from the camera assembly indicative of an image formed on a display surface of a three-dimensional (3D) display, wherein the 3D display comprises a plurality of pixels configured to form the image on the display surface and an image separating device configured to separate the image into a left-eye portion and a right-eye portion;
determining an alignment calibration based on the first signal and the second signal;
determining a first desired output direction of the left-eye portion of the image and a second desired output direction of the right-eye portion of the image based on the alignment calibration and the first signal; and
outputting a third signal to a display control system indicative of the first and second desired output directions.

17. The method of claim 16, wherein determining the first and second desired output directions comprises determining a desired position of the image separating device relative to the display surface, and wherein an actuator of the display control system is configured to adjust a position of the image separating device based on the third signal.

18. The method of claim 16, wherein determining the first and second desired output directions comprises determining a desired orientation of the 3D display relative to the head of the vehicle occupant, and wherein an actuator of the display control system is configured to adjust an orientation of the 3D display based on the third signal.

19. The method of claim 16, wherein determining the first and second desired output directions comprises determining a desired output of the plurality of pixels, and wherein a display controller of the display control system is configured to adjust an output of the plurality of pixels based on the third signal.

20. The method of claim 16, wherein the camera assembly comprises a first camera configured to monitoring the position of the head of the vehicle occupant and a second camera configured to monitor the image formed on the display surface, or a camera configured to monitor the position of the head of the vehicle occupant and the image formed on the display surface.
